(19) United States
(12) Patent Application Publication
(10) Pub. No.: US 2011/0305518 A1
(43) Pub. Date: Dec. 15, 2011

(54) SUBMERGED ELECTRICAL POWER GENERATING APPARATUS AND ACCESSORIES THEREFOR

(76) Inventors: Colin Richard Pearce, North Yorkshire (GB); Justin Nicholas Farrelly, Plano, TX (US)

(21) Appl. No.: 13/140,717

(22) PCT Filed: Dec. 10, 2009
(86) PCT No.: PCT/GB09/51678

§ 371 Date: Sep. 1, 2011

(30) Foreign Application Priority Data
Dec. 18, 2008 (GB) 0823062.5

(51) Int. Cl. E02B 9/00; H01B 7/24; B63B 21/50; B63B 21/26; F15D 1/00; B63B 21/24

(52) U.S. Cl. 405/75; 137/561 R; 405/224; 114/294; 174/136

(57) ABSTRACT

A deployment device for deploying a buoyant underwater electricity generating apparatus to a submerged location in a body of water is disclosed. The deployment device comprises a winding apparatus (14) adapted to be mounted to the electricity generating apparatus and adapted to engage an anchor chain (24) fixed to a floor of the body of water and to move along said anchor chain in a first direction to move the electricity generating apparatus to said submerged location. The deployment device also comprises a locking mechanism (38) having a locked condition in which movement of the winding apparatus along the anchor chain in a second direction, opposite to said first direction, is prevented when the locking mechanism is at a predetermined location on said anchor chain, and an unlocked condition in which said winding apparatus can move along the anchor chain in said second direction.

The present invention relates to accessories for underwater electrical power generating apparatus, and relates particularly, but not exclusively, to accessories for apparatus for generating electricity from tidal and constant marine currents.

An apparatus for generating electricity from water flow is disclosed in International patent application WO2008/081187. The apparatus is typically mounted to a flexible anchor chain at a desired depth underwater, and flow of water through the turbine of the apparatus causes electrical power to be generated, which can be taken off by means of one or more electrical cables extending from the apparatus.

This arrangement suffers from the drawback that it requires a subsea pulley system in order to deploy the generator to its operating location, and a separate surface operated release mechanism. This increases the cost and complexity of the apparatus.

This arrangement also suffers from the disadvantage that cables extending from the generator apparatus are under certain circumstances prone to damage as a result of water movement moving the cables against the sea floor. In order to overcome this problem, it is sometimes necessary to bury the cable in the sea floor, which is often expensive and difficult and may not always be possible, for example in the case of the sea floor being of hard rock.

The known arrangement suffers from the further disadvantage that the performance of the electricity generating apparatus is very sensitive to variations in water flow rate, as a result of which inlets and outlets to the generating apparatus have to be specially designed for the conditions experienced by the apparatus. This significantly increases the cost of manufacture of the apparatus.

Preferred embodiments of the present invention seek to overcome one or more of the above disadvantages.

According to an aspect of the present invention, there is provided a deployment device for deploying a buoyant apparatus to a submerged location in a body of water, the deployment device comprising:—

winding means adapted to be mounted to the buoyant apparatus and adapted to engage an anchor member fixed to a floor of the body of water and to move along said anchor member in a first direction to move the buoyant apparatus to said submerged location; and

locking means having a locked condition in which movement of the winding means along the anchor member in a second direction, opposite to said first direction, is prevented when the locking means is at a predetermined location on said anchor member, and an unlocked condition in which said winding means can move along the anchor member in said second direction.

By providing winding means adapted to be mounted to the generating apparatus and adapted to engage an anchor member fixed to a floor of the body of water and to move along said anchor member in a first direction to move the generating apparatus to the submerged location, this provides the advantage of providing a simpler, less costly deployment device, which is easier to maintain, since it can be retrieved and maintained and/or repaired at the same time as the generator apparatus.

The locking means may comprise a pair of first engaging members adapted to engage at least one stop member on said anchor member to prevent movement of at least one said stop member between said first engaging members, wherein said first engaging members are adapted to be moved further apart to allow movement of at least one said stop member past said first engaging members.

The locking means may further comprise release means for moving said first engaging members further apart to allow movement of at least one said stop member past said first engaging members.

The release means may further comprise at least one second engaging member adapted to protrude from a housing of the deployment device for moving said first engaging members further apart.

By providing at least one second engaging member adapted to protrude from a housing of the deployment device for moving said first engaging members further apart, this provides the advantage of providing a backup release mechanism if the main release mechanism should fail.

The first engaging members may be biased towards each other.

The device may further comprise deactivating means for deactivating said winding means when the deployment device reaches a predetermined position on said anchor member.

The deactivating means may be adapted to be activated by engagement by at least one stop member on said anchor member.

The winding means may be operable remotely from the device.

The winding means may include a drum for receiving part of said anchor member and/or a flexible winding member extending from said anchor member.

The device may further comprise braking means for resisting movement of the device along the anchor member in said second direction.

The braking means may comprise at least one third engaging member adapted to engage said drum.

The braking means may be adapted to be deactivated by means of said release means.

At least one said third engaging member may be adapted to be disengaged from the drum by means of at least one said second engagement member.

This provides the advantage of making the release mechanism easy to operate.

The device may further comprise feeding means for feeding at least one electrical cable connected to the buoyant apparatus into a storage portion of the device.

This provides the advantage of minimising the risk of damage to electrical cables connected to the generator apparatus, but minimising the length of loose cable.

The feeder means may be connected to said winding means.

This provides the advantage of synchronising operation of the feeder means and winding means, which simplifies the construction of the deployment device.

According to another aspect of the present invention, there is provided an electricity generating apparatus including at least one deployment device as defined above.

According to a further aspect of the present invention, there is provided a connection pod for electrical connection to an electricity generating apparatus, the connection pod including at least one deployment device as defined above.

According to a further aspect of the present invention, there is provided an anchor for an underwater electricity generating apparatus, the anchor comprising:—

an anchor body defining at least one hollow space connected to at least one respective aperture wherein said anchor body has a first condition in which the or each said aperture is sealed to prevent entry of water into the or each said hollow space, and a second condition in which water passes through at least one said aperture into at least one said hollow space to reduce the buoyancy of said anchor body;

attachment means for enabling attachment of an anchor member for an underwater electricity generating apparatus thereto when the anchor is located on a floor of a body of water; and

locating means for releasably locating at least one electrical cable connected to said generating apparatus adjacent said attachment means.

By providing an anchor body having a first condition in which the or each aperture is sealed to prevent entry of water into the or each hollow space, and a second condition in which water passes through at least one aperture into at least one hollow space to reduce the buoyancy of the anchor body, and locating means for releasably locating at least one electrical cable connected to the generating apparatus adjacent the attachment means, this provides the advantage of providing an anchor which is easier to deploy and connect to an electricity generating apparatus.

The anchor may further comprise floor engaging means for engaging a floor of a body of water to resist sliding of the anchor body relative to said floor.

The locating means may comprise at least one recess connected to an edge of said anchor body and at least one respective closure member for closing at least one said recess for releasably locating at least one said cable in said recess.

This provides the advantage of facilitating release of the cable from the anchor for maintenance or repair.

At least one said recess may have inclined walls.

This provides the advantage of minimising the risk of damage to a cable passing through said recess, especially during deployment of the anchor.

At least one said closure member may be located in use below an upper surface of said anchor body.

This provides the advantage of protecting cables passing through said recess.

The attachment means may be located in use below an upper surface of said anchor body.

This provides the advantage of providing a more stable arrangement which resists movement caused by tension in an anchor member connected to the attachment means.

The anchor may further comprise water directing means for generating downward force from water motion relative to said water directing means.

Said water directing means may comprise at least one fin mounted to said anchor body such that movement of water relative to said fin generates a downward force on the anchor device.

At least one said fin may be adapted to pivot relative to said anchor body to align itself with the direction of water flow.

According to a further aspect of the present invention, there is provided a method of deploying an anchor as defined above, the method comprising:—

supporting said anchor in said first condition of said anchor body; and

opening at least one said aperture to cause the anchor body to sink to the floor of a body of water in said second condition of said anchor body.

According to a further aspect of the present invention, there is provided a cable guard for at least one anchor member and/or at least one electrical cable connected to an underwater electricity generating apparatus, the cable guard comprising:—

a body having (i) a closed condition defining a substantially circular internal channel for receiving at least one anchor member and/or at least one electrical cable connected to an underwater electricity generating apparatus, wherein the body defines an elongate cross sectional external profile adapted to align itself with a direction of water flow, and (ii) an open condition in which said channel is open to receive at least one said anchor member and/or at least one said electrical cable.

By providing a body having (i) a closed condition defining a substantially circular internal channel for receiving at least one anchor member and/or at least one electrical cable connected to an underwater electricity generating apparatus, wherein the body defines an elongate cross sectional external profile adapted to align itself with a direction of water flow, and (ii) an open condition in which said channel is open to receive at least one said anchor member and/or at least one said electrical cable, this provides the advantage of providing a cable guard which minimises the risk of damage to the cable by water flow, but which is also easy to fit to the anchor member and cable.

The body may have first and second sides adapted to engage each other by means of respective first and second engaging members.

The elongate external profile may be substantially hydrofoil shaped.

According to a further aspect of the present invention, there is provided a cable protector for a cable connected to an underwater electricity generating apparatus, the cable protector comprising:—

at least one first body member defining (i) at least one cable engaging portion for rotatably engaging a cable and (ii) at least one floor engaging portion for engaging a floor of a body of water; and

at least one second body member defining (i) at least one cable engaging portion for rotatably engaging a cable and (ii) at least one said second floor engaging portion for engaging the floor of the body of water;

wherein at least one said first body member and at least one said second body member are adapted to be mounted to a cable such that said first and second floor engaging portions are arranged on opposite sides of the cable when the cable protector engages the floor of the body of water in use.

By providing first and second body members such that at least one first body member and at least one second body member are adapted to be mounted to a cable such that the first and second floor engaging portions are arranged on opposite sides of the cable when the cable protector engages the floor of the body of water in use, this provides the advantage of providing a cable protection device which reduces the need to bury the cable in the sea floor. This in turn reduces the cost of installation of an underwater electricity generating apparatus embodying the invention.

At least one said first body member and at least one said second body member may be adapted to engage each other as a result of bending of a cable engaged by said first and second body members, to thereby resist further bending of said cable.

This provides the advantage of providing protection against bending of the cable around too small a bend radius.

At least one said first and/or said second floor engaging portions may be adapted to resist movement of said cable relative to the floor of the body of water.

Said cable protector may have at least one inclined upper surface in use.

This provides the advantage of generating downward forces as a result of movement of water over the cable protector, which in turn increases the resistance to movement of the cable relating to the sea floor as a result of water movement.

The cable protector may further comprise attachment means for attaching the cable protector to the floor of the body of water.

At least one said first body portion may have at least one protrusion for engaging a respective recess on at least one said second body portion.

This provides the advantage of increasing the stability of the cable protector in use.

According to a further aspect of the present invention, there is provided a water flow adjustment assembly for forming a water flow adjustment device for adjusting the rate of flow of water into and/or out of an underwater electricity generating apparatus, the assembly comprising:

a plurality of water flow adjustment elements, each said element comprising a respective water flow adjustment surface; and

attachment means for enabling a plurality of said elements to be attached to each other to form a water flow adjustment device for adjusting the rate of flow of water passing through the device by means of a plurality of said water flow adjustment surfaces.

By providing a plurality of water flow adjustment elements, each comprising a respective water flow adjustment surface, which can be attached to each other to form a water flow adjustment device for adjusting the rate of flow of water passing through the device by means of a plurality of water flow adjustment surfaces, this provides the advantage of enabling an inlet or outlet to the electricity generating apparatus to be made from a modular construction to adjust the flow to match the optimum rating for the generating apparatus. This in turn enables the electricity generating apparatus to be of standardised construction and the water flow adjusting apparatus to modify the apparatus to operate efficiently in a wide range of operating conditions cost effective.

A plurality of said elements may be adapted to be attached to each other such that water can flow through at least one gap between at least one pair of adjacent said elements.

Preferred embodiments of the invention will now be described, by way of example only and not in any limitative sense, with reference to the accompanying drawings, in which:—

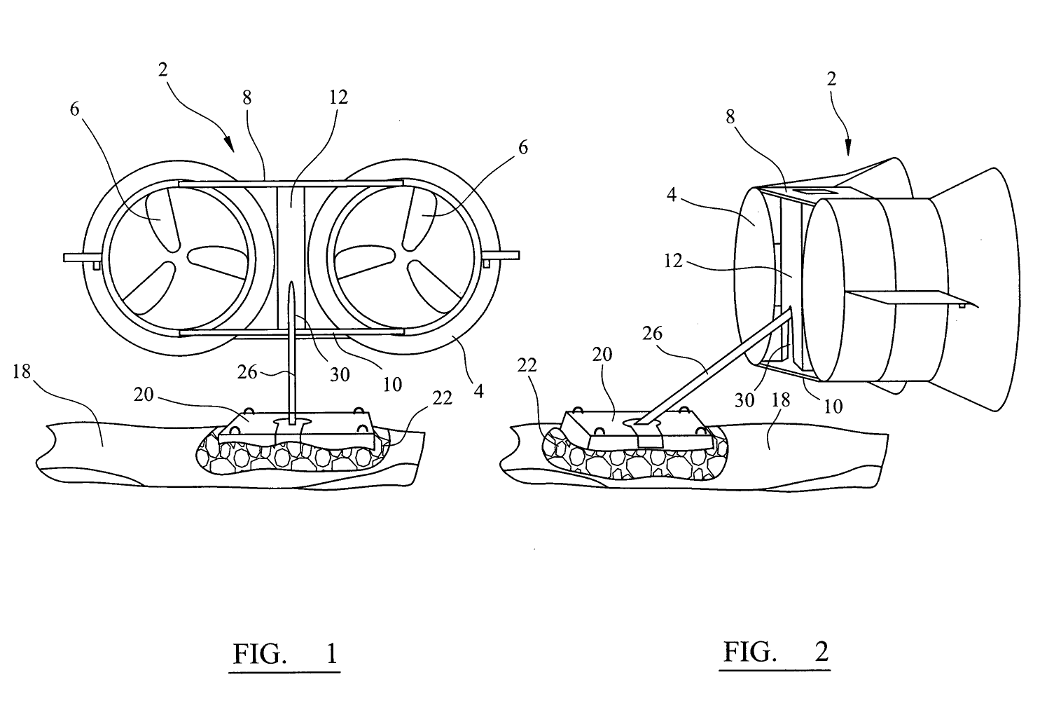

FIG. 1 is an end view of an underwater electricity generating apparatus embodying an aspect of the present invention;

FIG. 2 is a perspective view of the apparatus of FIG. 1;

FIG. 3 is a side cross sectional view of a deployment device of the apparatus of FIGS. 1 and 2;

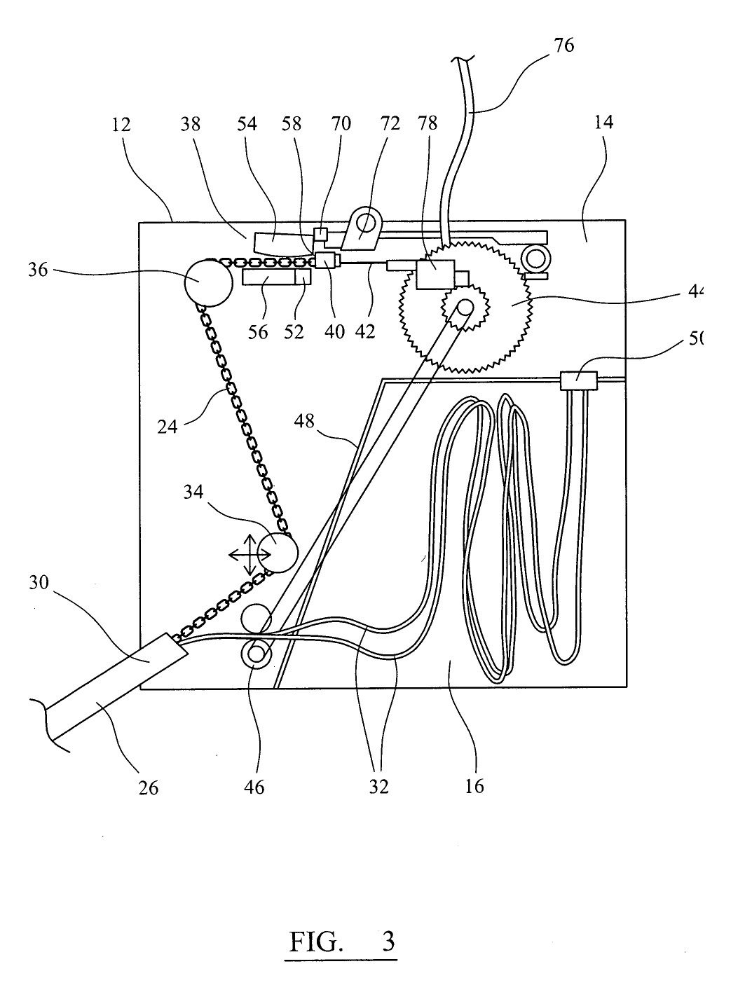

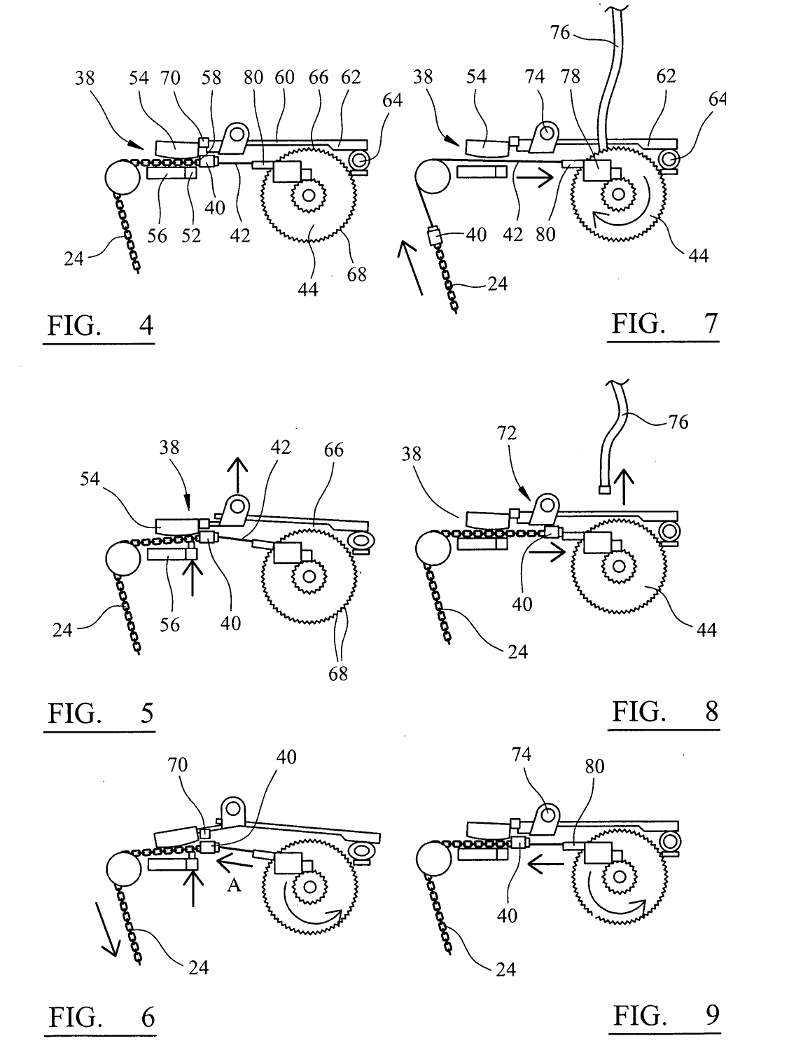

FIGS. 4 to 9 illustrate the operation of the deployment device of FIG. 3;

FIG. 10 is a schematic perspective view of a first embodiment of an anchor embodying an aspect of the present invention for an underwater electricity generating apparatus before deployment;

FIG. 11 is a view of the anchor of FIG. 10 after deployment;

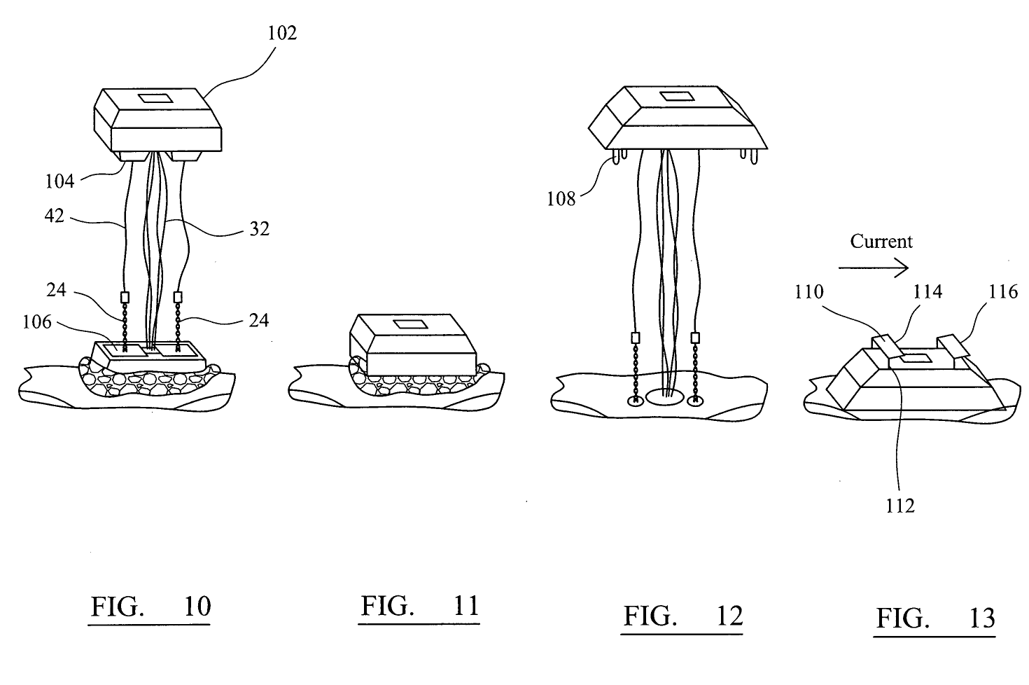

FIG. 12 is a schematic perspective view of a second embodiment of an anchor before deployment;

FIG. 13 is a view of the anchor of FIG. 12 after deployment;

FIG. 14 is a view from below of a first embodiment of an anchor embodying an aspect of the present invention;

FIG. 15 is a top view of the anchor of FIG. 14;

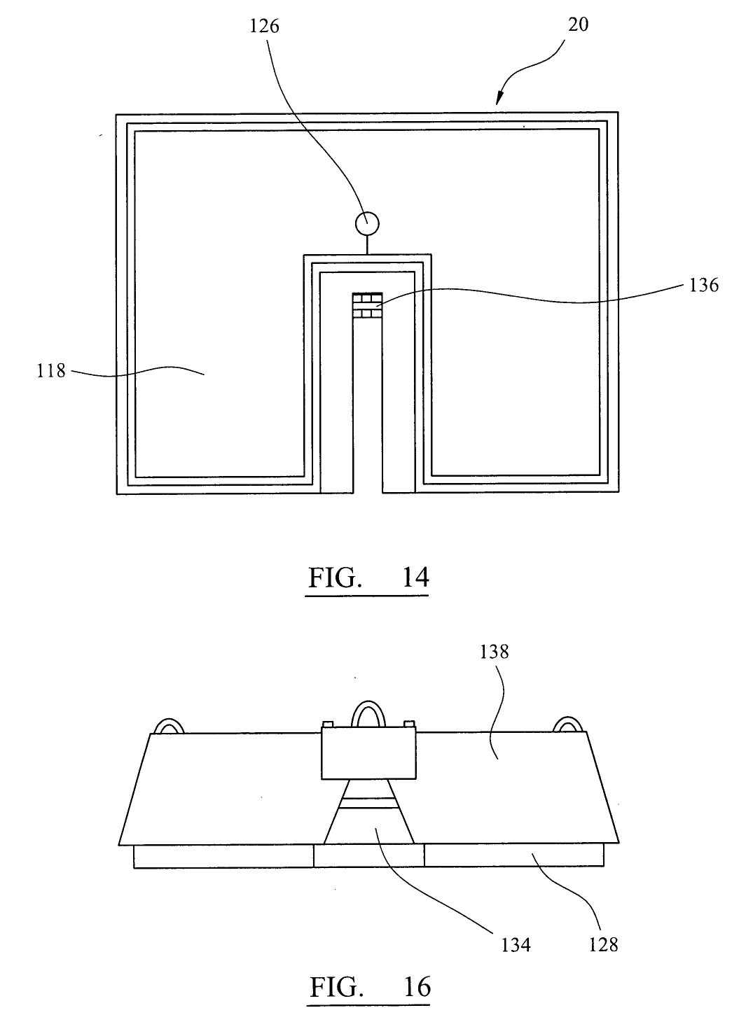

FIG. 16 is a side view of the anchor of FIG. 14;

FIG. 17 is a side cross sectional view of the anchor device of FIG. 14;

FIG. 18 is a side cross sectional view, corresponding to FIG. 17, of a second embodiment of an anchor;

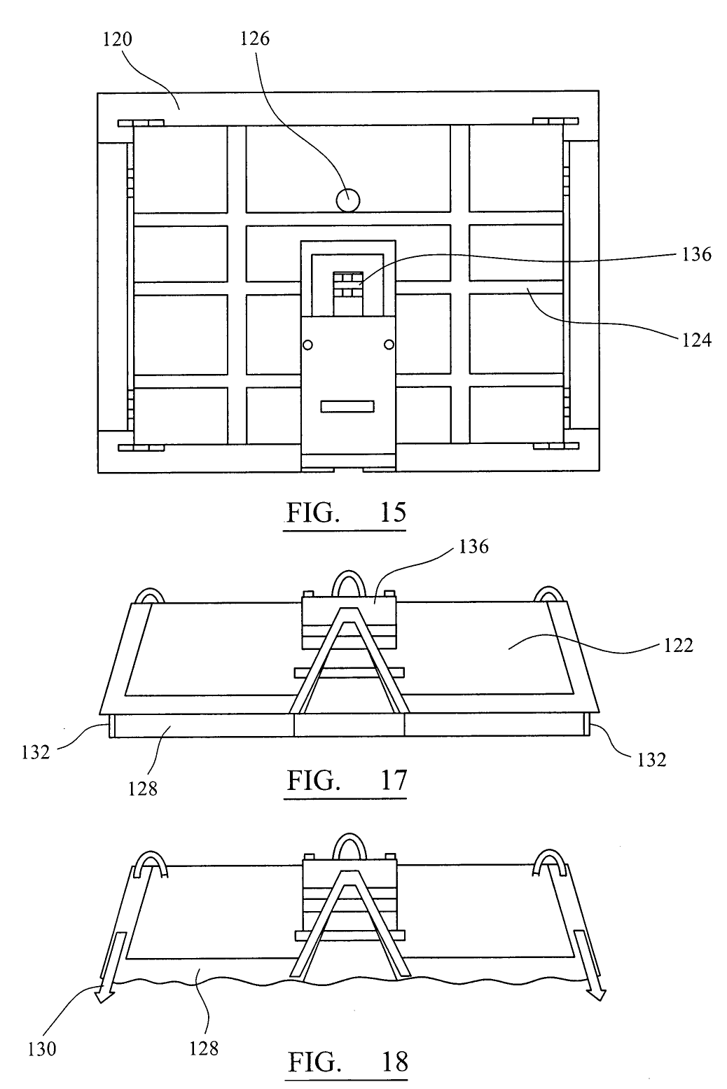

FIGS. 19 to 23 show a process of deployment of the anchor of FIGS. 14 to 18 and subsequent mounting of an electricity generating apparatus to the anchor;

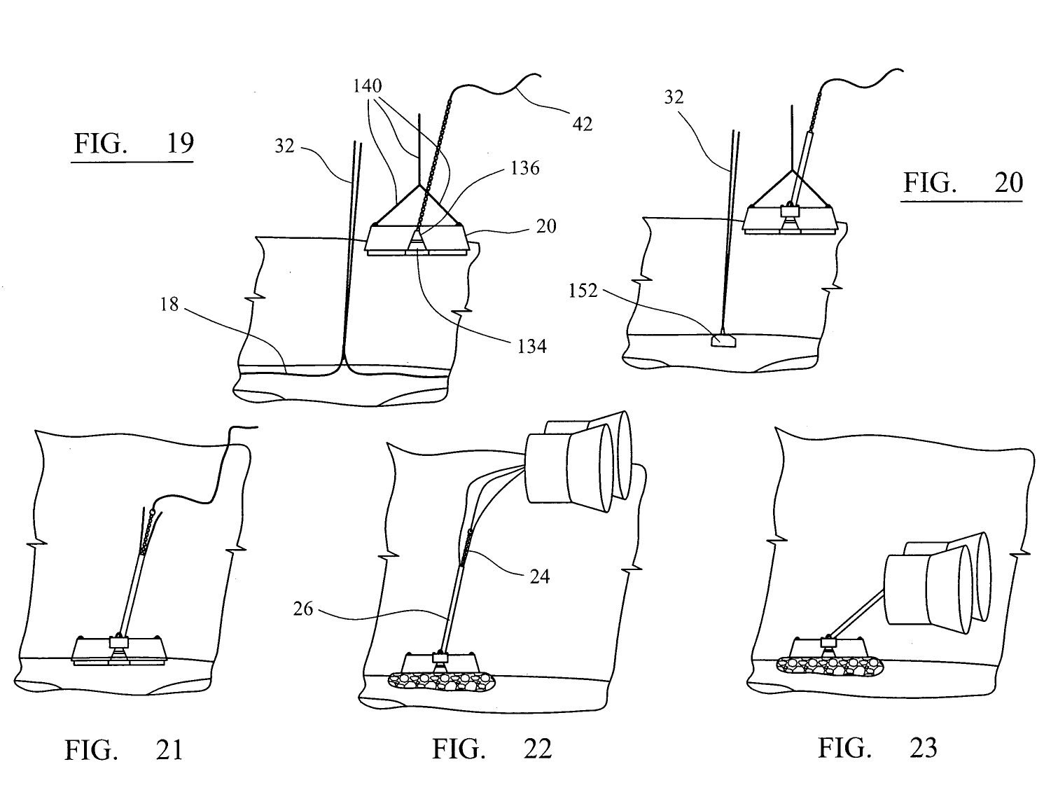

FIG. 24 is a perspective view of a cable guard embodying an aspect of the present invention for use with the anchor shown in FIGS. 19 to 23 and mounted to an anchor chain and a pair of electrical cables;

FIG. 25 is a side cross sectional view of the cable guard of FIG. 24 in a closed condition;

FIG. 26 is a side cross sectional view of the cable guard of FIG. 24 in an open condition;

FIG. 27 shows a schematic view of part of a first embodiment of a cable protector embodying an aspect of the present invention and mounted to a cable;

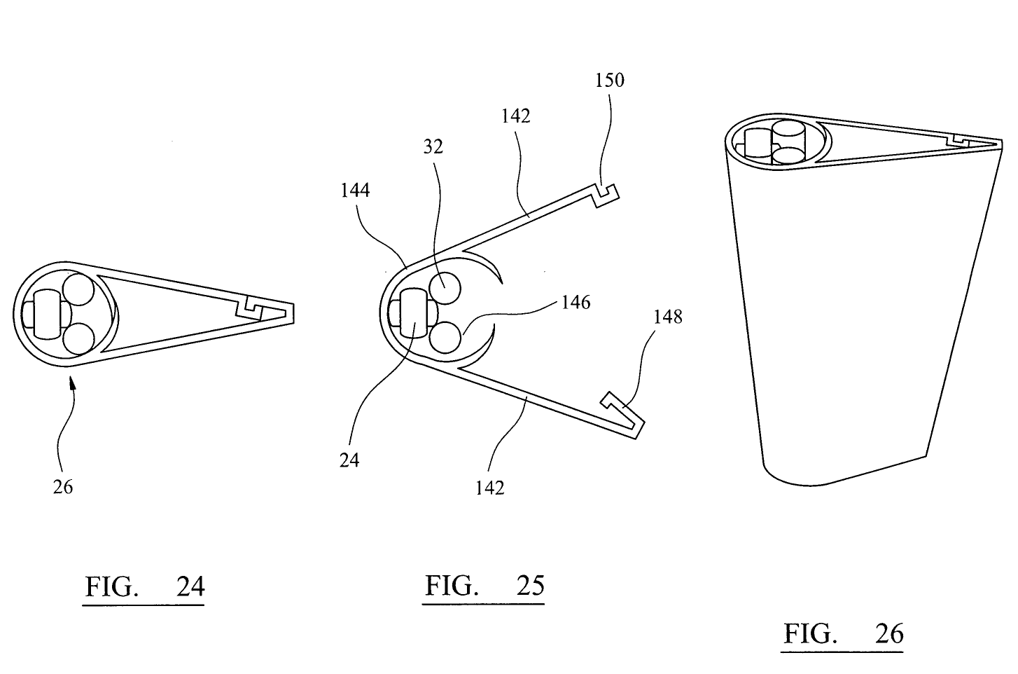

FIG. 28 shows the part of cable protector of FIG. 27 in a disassembled condition;

FIG. 29 is a cross sectional view of a first part of the cable protector of the cable protector of FIG. 27;

FIG. 30 is a cross sectional view of a second part of the cable protector of FIG. 27;

FIG. 31 is a cross sectional view of the arrangement of FIG. 27 during deployment;

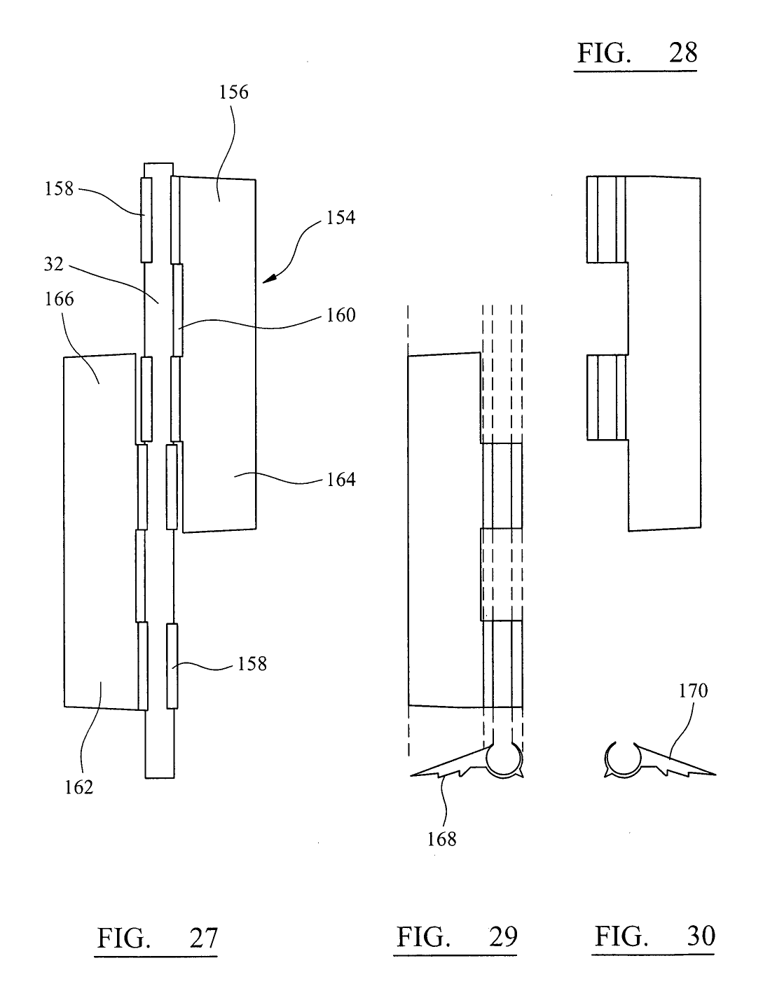

FIG. 32 is a cross sectional view of the arrangement of FIG. 27 after deployment;

FIG. 33 is a schematic view of a cable incorporating the part of FIG. 27 mounted to a cable and subjected to bending;

FIG. 34 is a schematic view, corresponding to FIG. 27, of part of a cable protector of a second embodiment of the present invention;

FIG. 35 is a side cross sectional view of a fastening arrangement of the cable protector of FIG. 34 prior to fastening thereof to the sea floor;

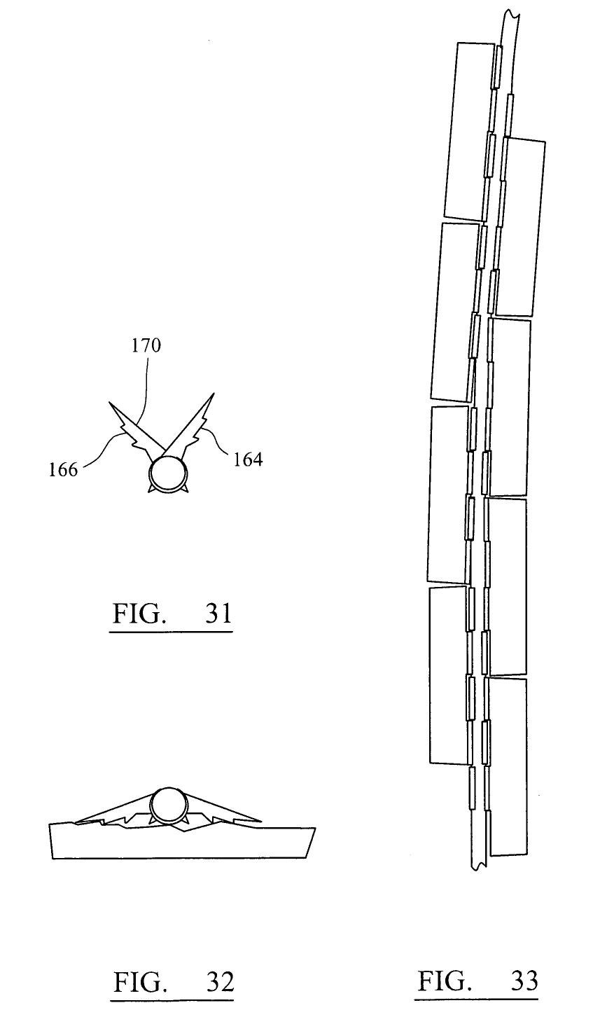

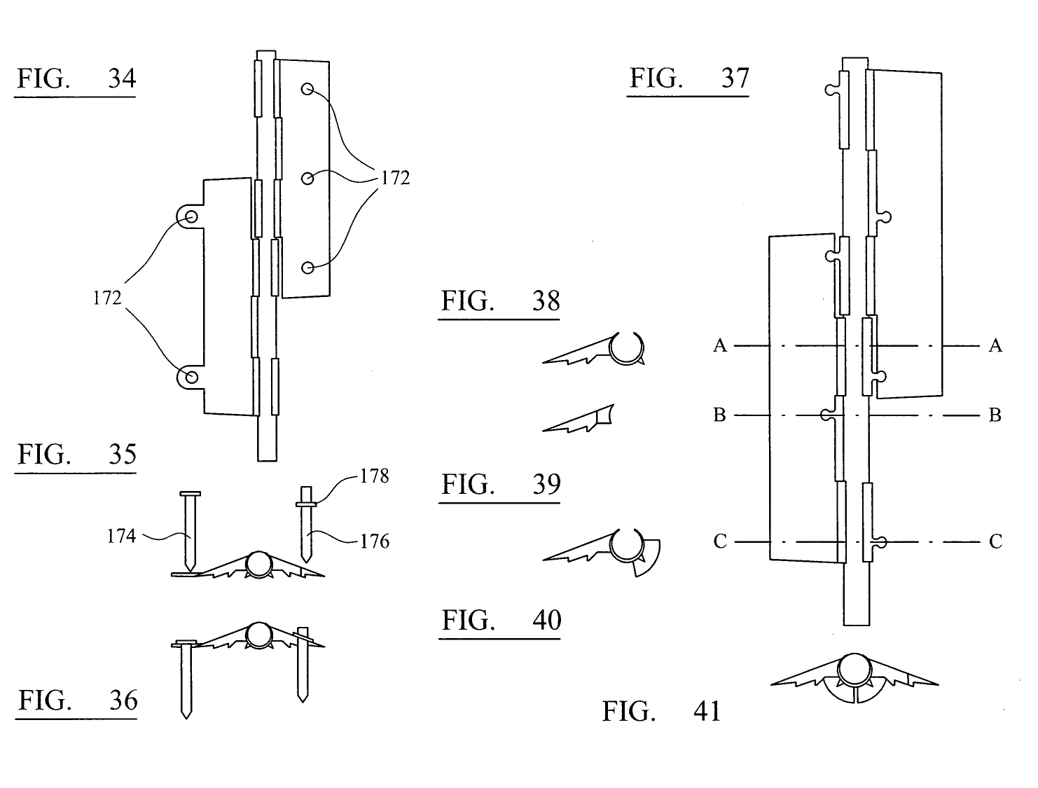

FIG. 36 shows the fastening arrangement of FIG. 35 after fastening thereof to the sea floor;

FIG. 37 is a schematic view of a cable protector of a third embodiment of the present invention;

FIG. 38 is a cross sectional view along the line A-A in FIG. 37 in the absence of a cable;

FIG. 39 is a view along the line B-B in FIG. 37;

FIG. 40 is a view along the line C-C in FIG. 37;

FIG. 41 is a cross sectional view of the arrangement of FIG. 37 when mounted to a cable;

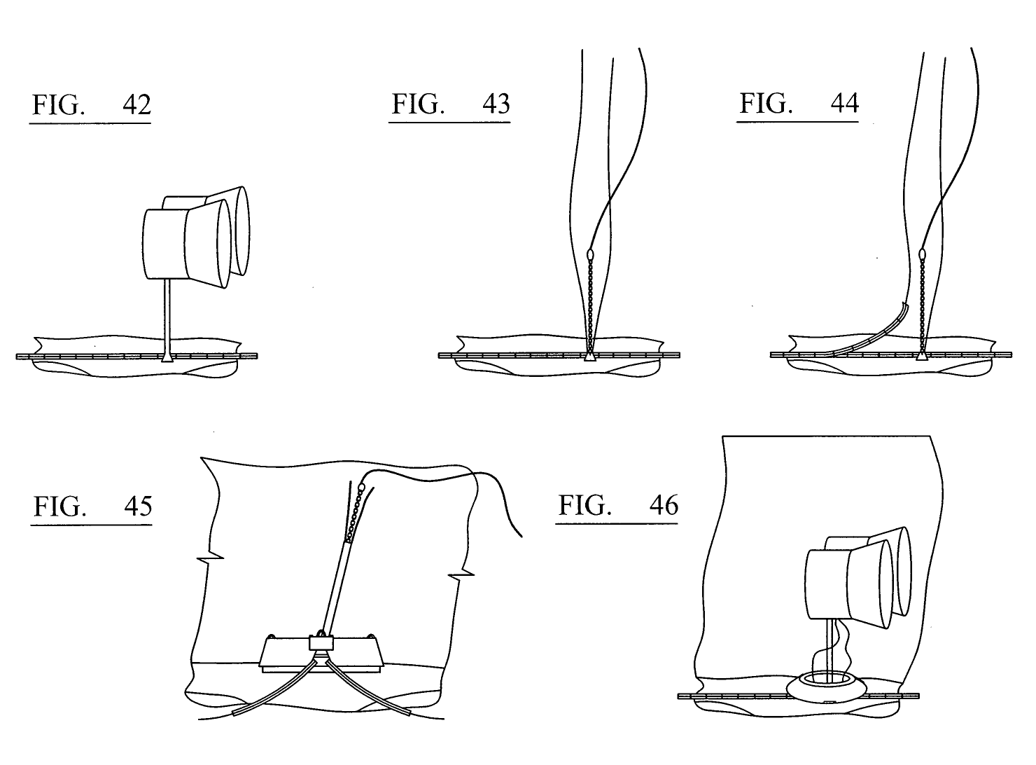

FIGS. 42 to 46 show uses of the cable guard of FIGS. 27 to 42;

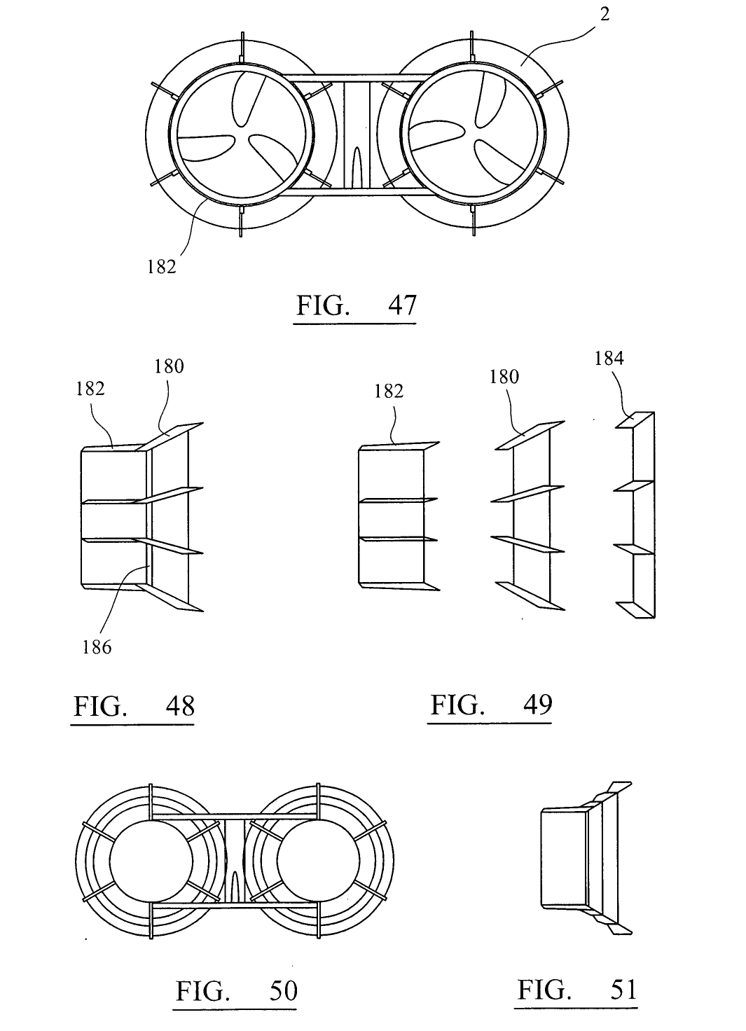

FIG. 47 is an end view of an electricity generating apparatus having a flow embodying an aspect of the present invention;

FIG. 48 is a side view of a first embodiment of the flow director of FIG. 47;

FIG. 49 is a side view of a second embodiment of the flow director of FIG. 47;

FIG. 50 is an end view of an electricity generating apparatus having a flow director of a third embodiment of the present invention; and

FIG. 51 is a side view of the flow director of FIG. 50.

Referring to FIGS. 1 and 2, an underwater electricity generating apparatus 2 of the type shown in International patent application WO2008/081187 comprises a pair of counter-rotating turbines 4 having inwardly directed turbine blades 6. The detailed operation of the turbines 4 is not relevant to the present invention and will therefore not be described in greater detail herein.

The turbines 4 are connected by means of a pair of horizontal connection foils 8, 10 which are in turn connected by means of a central vertical housing 12 containing a winding apparatus 14 and cable storage compartment 16 (FIG. 3). The generating apparatus 2 is anchored to the sea floor 18 by means of a gravity based anchor 20, to which rocks 22 are added for further stability. The apparatus 2 is anchored to the anchor 20 by means of a flexible anchor chain 24 (FIG. 3) located within a chain guard 26, which will be described in greater detail below with reference to FIGS. 24 to 26. The generator apparatus 2 is positively buoyant, and therefore floats within the water column at a height determined by the length of the chain 24 and any net forces (for example drag) acting on the apparatus 2 and chain guard 26 as a result of tidal or other current acting to pull the generator apparatus 2 downwards.

Referring to FIG. 3, the chain guard enters the vertical housing 12 through an access slot 30 where the anchor chain 24 and one or more electrical cables 32 connected to the generator apparatus 2 emerge from the chain guard 26. The chain 24 passes around an anchor point 34 and a secondary feeding pulley 36, through a locking mechanism 38 and engagement of a stop 40 connecting an end of the chain 24 to a retrieval cable 42 prevents removal of the chain 24 from the housing 12. The retrieval cable 42 is wrapped around a drum 44 of the winding apparatus 14. The electrical cables 32 pass between squirter rollers 46 which are connected by means of a chain 48 to an axle of the drum 44, and pass through storage compartment 16 to a suitable connection point 50.

Referring to FIGS. 3 to 6, in order to release the generating apparatus 2 from the anchor chain 24 so that it can rise to the water surface, a suitable remotely operable lifting mechanism 52 such as a bottle jack or worm jack is remotely activated to lift an upper part 54 of the locking mechanism 38, which in turn raises the stop 40 on the chain 24 out of engagement with a lower part 56 of the locking mechanism 38, as a result of engagement of the stop 40 with a raised nodule 58 on the upper part 54 of the locking mechanism 38 as shown in FIG. 5. At the same time, a brake member 60 pivots about pivot point 62 out of engagement with the outer periphery of the drum 44, and compresses a rubber fitting 64 which normally expands to bias a tooth 66 of the brake member 60 into engagement with one or more teeth 68 on the external periphery of the drum 44.

With continued upward movement of the upper part 54 of the locking mechanism 38 under the action of lifting mechanism 52, the stop 40 engages a fixed obstruction 70 which prevents further upward movement of the stop 40 but does not prevent further upward movement of the upper part 54 of the locking mechanism 38, as a result of which the stop 40 disengages from the nodule 58 on the upper part 54 of the locking mechanism 38. At the same time, the upper 54 and lower 56 parts of the locking mechanism 38 are sufficiently separated to allow the stop 40 to pass between the upper and lower parts 54, 56 in the direction of arrow A shown in FIG. 6, as a result of which the generating apparatus 2 can move towards the water surface under its own buoyancy, and the anchor chain 24, stop 40 and retrieval cable 42 pass out of the slot 30 in the vertical housing 12. The rate of ascent of the generator apparatus 2 is controlled by engagement of the brake member 60 with the outer periphery of the drum 44 under the action of the compressed rubber fitting 64 when the lifting mechanism 52 is released.

In the event of failure of the remotely controlled lifting mechanism 52, a backup release mechanism 72 is provided by means of a lifting point 74 connected directly to the upper part 54 of the locking mechanism 38 and which protrudes through an aperture in the upper surface of the housing 12. This enables attachment of a lifting hook such as a snatch hook, and a small lifting force releases the locking mechanism 38, which allows passage of the anchor chain 24 and stop 40 and allows the generator apparatus 2 to rise to the water surface. The weight of the upper part 54 of the locking mechanism 38 will normally prevent accidental activation of the backup release mechanism 72. Because of the connection of the drum 44 and squirter rollers 46 via the chain 48, as the anchor chain 24 and retrieval cable 42 are fed out of the housing 12, the electrical cables 32 are also fed out of the housing 12.

When the generator apparatus 2 reaches the water surface, it can be lifted onto the back deck of a suitable surface vessel (not shown) and the retrieval cable 42 and electrical cables 32 can be disconnected from the generator apparatus 2 in relative safety on board the vessel and the generator 2 removed to shore for maintenance, inspection, repair or the like. During the temporary absence of the generator apparatus 2, an alternative generator (not shown) can be substituted and deployed, or dummy connections made to the electrical cables 32 and the retrieval cable 42 and these then secured temporarily to a buoy or the like for subsequent reconnection to the repaired generator apparatus 2.

Referring to FIGS. 3 and 7 to 9, in order to redeploy the generator device 2 to its submerged location, while on the deck of the surface vessel the electrical cables 32 and retrieval cable 42 are reconnected to the generator 2 and a suitable power source (not shown) such as a hydraulic, pneumatic or electrical power source is connected via a hose 76 or electrical cable to a hydraulic motor drive 78 connected to the drum 44. The generator 2 is then lifted overboard into the water, and power supplied via the hose 76 or cable to the motor drive 78, as a result of which the motor drive 78 causes the drum 44 to rotate to pull the retrieval cable 42, and subsequently the anchor chain 24, into the housing 12 to submerge the generator 2.

Eventually, the stop 40 passes through the locking mechanism 38 by displacing the upper part 54 of the locking mechanism 38, and the upper part 54 of the locking mechanism 38 then returns under its own weight after passage of the stop 40 to prevent passage of the stop 40 in the opposite direction to thereby prevent removal of the stop 40 from the housing 12. The stop 40 then engages a hydraulic release button 80 which deactivates the motor drive 78 and/or releases the power source, and the resulting lack of hydraulic pressure allows the winding apparatus 14 to relax and the stop 40 to secure itself against the locking mechanism 38 under the action of the buoyancy of the generator apparatus 4. The brake member 60 maintains a small tension on the retrieval cable 42 and prevents further relaxation of the winding apparatus 14 to secure the retrieval cable 42 on the drum 44. During rotation of the drum 44, the squirter rollers 46 rotate in synchronism with the drum 44 as a result of the chain 48, which reels in the electrical cables 32 into the storage compartment 16.

It will be appreciated by persons skilled in the art that since the retrieval cable 42 is only used for redeploying the generator apparatus 2, it only requires sufficient strength to overcome the buoyancy of the generator apparatus 2. As a result, the retrieval cable 42 can be of lower strength than the anchor chain 24. This enables a reduction in weight and cost.

Referring to FIGS. 10 to 13, a subsea pod 102 used for the collection of multiple electrical cables 32 and further onward connection on either to shore or to other pods, is deployed by means of one or more winding mechanisms 14 as shown in FIG. 3. The pod 102 is arranged to have positive buoyancy for retrieval purposes, and is connected to a gravity based anchor 20 or directly to the sea floor 18 by means of a pair of anchor chains 24 and retrieval cables 42. The use of multiple anchor chains 24 allows the power pod 102 to be lowered into position with a specific orientation, and angled male 104 and female 106 mating elements are used to guide the pod 102 into its final position on the gravity based anchor 20.

When the pod 102 reaches the sea floor 18, it can be further secured to the seabed 18 by pushing spikes 108 (FIG. 12) into the seabed, or by means of hydrodynamic foils 110 (FIG. 13) which create a downward force when water passes over the foils 110. These are mounted on a rigid bar 112 and the foil tail 114 rests against a raised support bar 116 to provide the necessary downward force, such as the tide changes direction, the hydrodynamic foil 110 pivots about the bar 112 and flips over.

Referring the FIGS. 14 to 18 a gravity based anchor 20 for the generator apparatus 2 shown in FIG. 1 comprises a hollow concrete shell 118 having side walls 120 defining a hollow chamber 122. A series of reinforcements 124 of steel, carbon fibre or other suitable reinforcing material provide additional support and tenstile strength, and entry of water into the hollow chamber 122 is prevented by sealing one or more apertures 126 in the concrete shell 118. The bottom edge 128 of the concrete shell 118 is roughened (FIG. 18) to increase its frictional drag on the sea floor, or spikes 130 may be provided to engage the sea floor to increase the lateral resistance to motion in a tidal current. Alternatively, a skirt 132 may be provided around the base of the concrete shell 118 which is either pressed into the sea floor under the weight of the anchor 20 when filled with water, and/or by means of additional weight such as ballast.

The concrete shell 118 is provided with a slot 134 which extends from an edge of the shell 118 to a centre region where an anchor point 136 is provided below the upper surface 138 of the concrete shell 118. This enables cables to be located near to an anchor chain connected to the anchor point 136.

Referring to FIGS. 19 to 23, in order to deploy the gravity based anchor 20 of FIGS. 14 to 18, the anchor chain 24 and retrieval cable 42 are connected to the anchor point 136, and the concrete shell 118 is positioned alongside a surface vessel (not shown) by means of support cables 140 connected to a lifting crane on the support vessel. The power and/or data electrical cables 32 are pre installed on the sea floor 18 and are fed into the slot 134 in the concrete body 118 such that the cables 32 are located adjacent the anchor chain 24 connected to the anchor attachment point 136. A cover plate 140 is then fitted to the slot 134 to secure the cables 32 in position adjacent the anchor chain 24, and a chain guard 26 is wrapped around the chain 24 (FIGS. 24 to 26) by separating arms 142 of the chain guard body 144 to open circular channel 146 to receive the anchor chain 24 and electrical cables 32, then closing the arms 142 and engaging male 148 and female 150 engagement parts to close the circular channel 146 around the anchor chain 24 and electrical cables 32. This holds the chain 24 and cables 32 securely together, while allowing some relative motion of the cables 32 relative to the chain 24 and allowing the chain guard 26 to rotate with the tide around the chain, offering a small drag profile. The chain guard 26 is preferably of such a length that it extends from inside the slot 134 on the gravity based anchor 20 at one end to a location inside the housing of the generator apparatus 2 at the other end to minimise damage to the cable 32.

The anchor is then scuttled by removing plugs (not shown) from apertures 126 to allow water to enter the chamber 122 to cause the anchor body 20 to submerge, the submerged weight of the anchor 20 being taken by the vessel crane. The anchor body 20 is then lowered to the sea floor 18 over cable exit hole 152. Foils similar to those shown in FIG. 13 can be attached to the anchor body 20 to provide additional down force, and dense material is piled up around the anchor body. The cables 32 and retrieval cable 42 are then connected to the generator apparatus 2, which is then deployed to its submerged condition shown in FIG. 23 by means of the deployment method described above. Since all electrical and mechanical connections are made on board the surface vessel, no wet mate connections for electrical cables are required.

It is known to pre-bury subsea electrical cables in the sea floor by means of known trenching and/or plough technology. Whilst this provides good protection against fretting and accidental damage from anchor movements, it is very expensive and can be very difficult to achieve under certain sea floor conditions and does not allow for replacement of damaged cables. A cable protector 154 is shown in FIGS. 27 to 41 which overcomes these difficulties by protecting a cable 32 which lies on the sea floor and which does not need to be buried.

Referring to FIGS. 27 to 33, a first embodiment of the cable protector 154 is formed from a first cable protector body 156 having interleaving flexible cylindrical sections 158 which fit over a continuous cable 32 separated by spaces 160 which are interleaved with corresponding sections of a second cable protector element 162. The cable protector bodies 156, 162 each define a respective sea floor engaging part 164, 166 having a series of ridges 168 or protuberances to resist motion of the cable 32 relative to the sea floor under the influence of water motion. The assembled cable protector 154 also has an upper surface 170 which is inclined at a shallow angle to any on-rushing water movement, as a result of which water movement further increases the down force on the sea floor cable to help maintain the cable in a stable position.

In order to deploy the cable with the cable protector, the cable mounted to the cable protector is placed in the water in the configuration shown in FIG. 31, and will then adopt the configuration shown in FIG. 32 when it engages the sea floor. This ensures that the cable faces the correct orientation when it arrives at the sea floor, and the floor engaging portions 164, 166 then lower themselves under gravity to adopt their long term rest position on the sea floor. In order to retrieve a damaged cable from the gravity based anchor, the generator apparatus 2 is retrieved to the surface and disconnected from the cables, and the chain guard 26 and cover plate 140 are removed using suitable apparatus such as a grab claw or similar device deployed from a surface vessel. The cable and sea floor cable cover can then be lifted out from the gravity based anchor through the slot and are then lifted directly from the surface vessel and removed, repaired and/or replaced as appropriate. Limited pivoting of adjacent parts of the cable protector device relative to each other is permitted, to prevent the cable from being bent around too small a bend radius.

Referring to FIGS. 34 to 36, a further embodiment of a cable cover is shown, in which holes 172 are distributed along the cable cover flaps or through extension parts to enable pinning of the cable cover to the sea floor when the sea floor is formed from hard rock. Pinning may be carried out using industrial headed nails 174 or simple spikes 176 having O-rings 178. This could be carried out by means of a suitable remotely operated vehicle (ROV) having a roll along device. The use of vertical lift pins 176 enables removal of the cable cover for subsequent repair while leaving the pins in place in the sea floor.

Referring to FIG. 46, an additional terminal enclosure for protecting cables as they leave the cable cover is shown. The terminal enclosure is generally conical in shape to minimise drag resistance of currents, and may have an undulating bottom profile to allow easy passage of the sea floor cable cover and cable under the enclosure.

Referring to FIGS. 47 to 51 a funnel arrangement for the generator apparatus is shown. Such funnel could be a flow concentrator upstream of the turbine apparatus 2, or a diffuser downstream of the apparatus.

FIGS. 47 to 49 show a twin ducted turbine 2 with Venturi 180 provided as a separate component. Mounting means on either a duct 182 of the generator apparatus 2, the Venturi 180, or both allows any Venturi design to be fitted to the duct 182. Using a standard rated turbine 2 within a standard duct 182, a standard minimum venturi 180 can then be selected appropriate for the flow regime the turbine 2 is to be located within. This standard venturi will be the smallest venturi required throughout the tidal stream thereby representing the fastest tidal currents. Where tidal stream is weaker one or more additional Venturis 184 can be connected to standard venturi 180 to further augment the water flow through this turbine and increase power to the same level as all other turbines within this array and thus standardise output making interconnection simpler and ensuring all devices 2 are operating at rated design, thereby minimising overstressing of components or underuse of rated machinery.

Between the duct 182 and the standard venturi 180 and between the standard venturi and the supplemental venturis 184 one or more slots 186 may be provided for limited water flow to enter into the Venturi. If slots are allowed, this increased water flow encourages recombination of the water flow through at the boundary of the Venturi, minimising eddies and boundary layer effects within the venturi, which can degrade its efficacy.

Multiple additional venturis may be added as shown in FIGS. 50 and 51.

It will be appreciated that the same standard ducted turbine with no or minimal venturi could be used in a highly energetic tidal regime as a standard ducted turbine with a single large or a cascading arrangement of multiple venturis in a less energetic regime, thus allowing standardisation of standard turbine and duct configurations across a wide range of tidal flow regimes.

It will be appreciated by persons skilled in the art that the above embodiments have been described by way of example only, and not in any limitative sense, and that various alterations and modifications are possible without departure from the scope of the invention as defined by the appended claims.

1. A deployment device for deploying a buoyant apparatus to a submerged location in a body of water, the deployment device comprising:—
at least one winding device adapted to be mounted to the buoyant apparatus and adapted to engage an anchor member fixed to a floor of the body of water and to move along said anchor member in a first direction to move the buoyant apparatus to said submerged location; and
at least one locking device having a locked condition in which movement of at least one said winding device along the anchor member in a second direction, opposite to said first direction, is prevented when the locking device is at a predetermined location on said anchor member, and an unlocked condition in which at least one said winding device can move along the anchor member in said second direction.

2. A deployment device according to claim 1, wherein at least one said locking device comprises a pair of first engaging members adapted to engage at least one stop member on said anchor member to prevent movement of at least one said stop member between said first engaging members, wherein said first engaging members are adapted to be moved further apart to allow movement of at least one said stop member past said first engaging members.

3. A deployment device according to claim 2, wherein at least one said locking device further comprises at least one release device for moving said first engaging members further apart to allow movement of at least one said stop member past said first engaging members.

4. A deployment device according to claim 3, wherein at least one said release device further comprises at least one second engaging member adapted to protrude from a housing of the deployment device for moving said first engaging members further apart.

5. A deployment device according to claim 2, wherein the first engaging members are biased towards each other.

6. A deployment device according to claim 1, further comprising at least one deactivating device for deactivating at least one said winding device when the deployment device reaches a predetermined position on said anchor member.

7. A deployment device according to claim 6, wherein at least one said the deactivating device is adapted to be activated by engagement by at least one stop member on said anchor member.

8. A deployment device according to claim 1, wherein at least one said winding device is operable remotely from the device.

9. A deployment device according to claim 1, wherein at least one said winding device includes a drum for receiving part of said anchor member and/or a flexible winding member extending from said anchor member.

10. A deployment device according to claim 1, further comprising at least one braking device for resisting movement of the device along the anchor member in said second direction.

11. A deployment device according to claim 10, wherein at least one said braking device comprises at least one third engaging member adapted to engage said drum.

12. A deployment device according to claim 3, wherein at least one said braking device is adapted to be deactivated by means of at least one said release device.

13. A deployment device according to claim 4, wherein at least one said third engaging member is adapted to be disengaged from the drum by means of at least one said second engagement member.

14. A deployment device according to claim 1, further comprising at least one feeding device for feeding at least one electrical cable connected to the buoyant apparatus into a storage portion of the device.

15. A deployment device according to claim 14, wherein at least one said feeder device is connected to at least one said winding device.

16. An electricity generating apparatus including at least one deployment device according to claim 1.

17. A connection pod for electrical connection to an underwater electricity generating apparatus, the connection pod including at least one deployment device according to claim 1.

18. An anchor for an underwater electricity generating apparatus, the anchor comprising:—
an anchor body defining at least one hollow space connected to at least one respective aperture wherein said anchor body has a first condition in which the or each said aperture is sealed to prevent entry of water into the or each said hollow space, and a second condition in which water passes through at least one said aperture into at least one said hollow space to reduce the buoyancy of said anchor body;
at least one attachment device for enabling attachment of an anchor member for an underwater electricity generating apparatus thereto when the anchor is located on a floor of a body of water; and
at least one locating device for releasably locating at least one electrical cable connected to said generating apparatus adjacent at least one said attachment device.

19. An anchor according to claim 18, further comprising at least one floor engaging device for engaging a floor of a body of water to resist sliding of the anchor body relative to said floor.

20. An anchor according to claim 18, wherein at least one said locating device comprises at least one recess connected to an edge of said anchor body and at least one respective closure member for closing at least one said recess for releasably locating at least one said cable in said recess.

21. An anchor according to claim 20, wherein at least one said recess has inclined walls.

22. An anchor according to claim 20, wherein at least one said closure member is located in use below an upper surface of said anchor body.

23. An anchor according to claim 18, wherein at least one said attachment device is located in use below an upper surface of said anchor body.

24. An anchor according to claim 18, further comprising at least one water directing device for generating downward force from water motion relative to said water directing device.

25. An anchor according to claim 24, wherein at least one said water directing device comprises at least one fin mounted to said anchor body such that movement of water relative to said fin generates a downward force on the anchor device.

26. An anchor according to claim 25, wherein at least one said fin is adapted to pivot relative to said anchor body to align itself with the direction of water flow.

27. A method of deploying an anchor according to claim 18, the method comprising:—
supporting said anchor in said first condition of said anchor body; and
opening at least one said aperture to cause the anchor body to sink to the floor of a body of water in said second condition of said anchor body.

28. A cable guard for at least one anchor member and/or at least one electrical cable connected to an underwater electricity generating apparatus, the cable guard comprising:—
a body having (i) a closed condition defining a substantially circular internal channel for receiving at least one anchor member and/or at least one electrical cable connected to an underwater electricity generating apparatus, wherein the body defines an elongate cross sectional external profile adapted to align itself with a direction of water flow, and (ii) an open condition in which said channel is open to receive at least one said anchor member and/or at least one said electrical cable.

29. A cable guard according to claim 28, wherein the body has first and second sides adapted to engage each other by means of respective first and second engaging members.

30. A cable guard according to claim 28, wherein the elongate external profile is substantially hydrofoil shaped.

31. A cable protector for a cable connected to an underwater electricity generating apparatus, the cable protector comprising:—
at least one first body member defining (i) at least one cable engaging portion for rotatably engaging a cable and (ii) at least one floor engaging portion for engaging a floor of a body of water; and
at least one second body member defining (i) at least one cable engaging portion for rotatably engaging a cable and (ii) at least one said second floor engaging portion for engaging the floor of the body of water;
wherein at least one said first body member and at least one said second body member are adapted to be mounted to a cable such that said first and second floor engaging portions are arranged on opposite sides of the cable when the cable protector engages the floor of the body of water in use.

32. A cable protector according to claim 31, wherein at least one said first body member and at least one said second body member are adapted to engage each other as a result of bending of a cable engaged by said first and second body members, to thereby resist further bending of said cable.

33. A cable protector according to claim 31, wherein at least one said first and/or said second floor engaging portion may be adapted to resist movement of said cable relative to the floor of the body of water.

34. A cable protector according to claim 31, wherein said cable protector has at least one inclined upper surface in use.

35. A cable protector according to claim 31, further comprising at least one attachment device for attaching the cable protector to the floor of the body of water.

36. A cable protector according to claim 31, wherein at least one said first body portion has at least one protrusion for engaging a respective recess on at least one said second body portion.

37. A water flow adjustment assembly for forming a water flow adjustment device for adjusting the rate of flow of water into and/or out of an underwater electricity generating apparatus, the assembly comprising:
a plurality of water flow adjustment elements, each said element comprising a respective water flow adjustment surface; and
at least one attachment device for enabling a plurality of said elements to be attached to each other to form a water flow adjustment device for adjusting the rate of flow of water passing through the device by means of a plurality of said water flow adjustment surfaces.

38. A water flow adjustment assembly according to claim 37, wherein a plurality of said elements are adapted to be attached to each other such that water can flow through at least one gap between at least one pair of adjacent said elements.
